(19) United States
(12) Patent Application Publication
(10) Pub. No.: US 2016/0321439 A1
(43) Pub. Date: Nov. 3, 2016

(54) Connection Prediction As Identity Verification

(71) Applicant: LinkedIn Corporation, Mountain View, CA (US)

(72) Inventors: DARIA AXELROD MARMER, Mountain View, CA (US); STEPHANIE LUCAS, Santa Cruz, CA (US); VLAD SHLOSBERG, San Francisco, CA (US)

(21) Appl. No.: 14/698,090

(22) Filed: Apr. 28, 2015

(51) Int. Cl. G06F 21/31; H04L 29/06

(52) U.S. Cl. CPC G06F 21/31; H04L 63/08

(57) ABSTRACT

A method comprises receiving a request to verify an identity of a target user, identifying a user connected to the target user, identifying a second user connected to the first user and the target user, and identifying a third user. The method further comprises displaying, to the target user, identifying information of the first, second and third users, and prompting the target user to indicate to which of the second user and the third user the first user is connected.

### TECHNICAL FIELD

The present disclosure relates generally to verifying the identity of a user of a computer, application, service, website, or other product.

### BACKGROUND

Verifying the identity of users is a challenging problem. In particular, the challenge becomes harder when the verification is not performed in person. For example, a server at a restaurant may easily verify the identity of a customer by checking their government issued identification card to see if the card looks authentic and that the picture on the card matches the individual presenting the identification. In contrast, if a user signs up for a social networking service using a computer, authenticating the user becomes much harder.

Various solutions have been developed to attempt to solve this problem. One solution requires the user to provide external confirmation, such as entering a phone number where the user may receive a text message with a code. Once received, the user enters the code as verification. While better than no verification, this solution has many relatively easy workarounds, such as using a friend's phone number and/or buying a new phone number. A similar solution is commonly used with e-mail: the confirmation code is sent to a user-provided e-mail address and, once the user enters the confirmation code from the e-mail, the user is authenticated.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 shows a block diagram of a system in accordance with an embodiment of the invention.

FIG. 2 shows a flowchart of a method in accordance with an embodiment of the invention.

FIGS. 3A-3C show examples in accordance with an embodiment of the invention.

FIG. 4 shows a block diagram of a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are provided for verification of an identity of a target user based on the target user successfully identifying connections. In one embodiment, the identity of a user within a social network is verified. However, embodiments may be used in many different contexts where a user is connected to other users.

In one embodiment, the verification is performed in response to detecting suspicious behavior by, or relating to, the target user. In response to a request, a first user connected to the target user is identified, and a second user connected to the target user and the first user is also identified. When verifying the target user, identifying information of the first user, the second user, and other users are displayed to the target user, and the target user is prompted to indicate which of the displayed users (i.e., the second user and the other users) the first user knows. For example, the target user may be presented with a question of “Who does Sam know?” and asked to make a selection from “Andy, Jen, or Bryson.” If the target user is able to correctly answer the question, then that indicates that the target user actually knows (or is likely to know) who he or she has connected with, and is a good indication that the target user is an authentic user.

### Example System Implementation

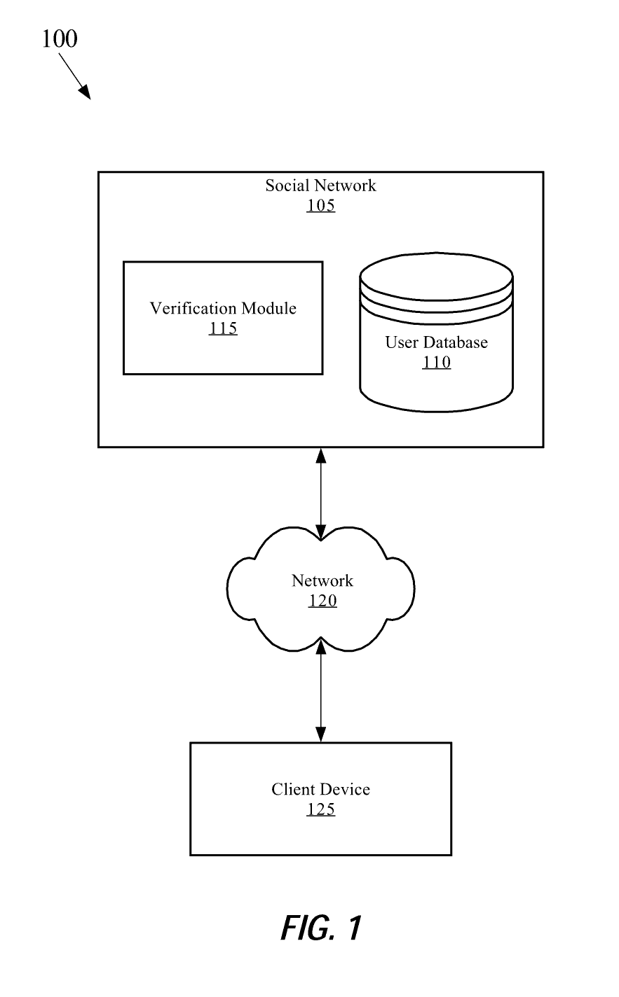

FIG. 1 illustrates an example system 100 in which the techniques described may be practiced, according to some embodiments. System 100 is a computer-based system. The various components of system 100 are implemented at least partially by hardware at one or more computing devices, such as one or more hardware processors executing instructions stored in one or more memories for performing various functions described herein. System 100 illustrates only one of many possible arrangements of components configured to perform the functionality described herein. Other arrangements may include fewer or different components, and the division of work between the components may vary depending on the arrangement.

System 100 includes social network 105, a user database 110, a verification module 115, a network 120, and one or more client devices 125. Social network 105 is a service for connecting users to other users. The connections may take many different forms. For example, connections may be unidirectional or bidirectional, and approval by one or both users may be required. Alternatively, approval may not be required. In general, social network 105 allows users to interact with other users of the social network by sending messages, posting pictures, sharing links, networking, and performing a variety of other actions. Social network 105 executes on one or more computing devices such as servers, computers, processors, database servers, and/or computing devices configured to communicate with one or more client devices 125 via network 120. The computing devices on which social network 105 executes may be located at one or more geographically distributed locations.

In one embodiment, social network 105 includes a user database 110. User database 110 is a database containing a variety of information about the users of social network 105. For example, user database 110 may include, but is not limited to: connections or connection graphs for each user and/or for various groups of users, user profiles, messages sent and/or received by users, pictures uploaded by users, and/or any other data relating to users of the social network 105. In one embodiment, the user profiles stored by user database 110 include user supplied identifying information including, but not limited to: a profile picture, a first name, a last name, a middle name, a work place(s), a degree(s) earned, a college or university attended, one or more groups associated with the user (i.e., a fraternity, a church, a volunteer organization, etc.), skills, and/or other data. Although shown as a single database, user database 110 may be broken into multiple different databases in any number of geographic locations, with each database storing different types of information, or any other suitable configuration.

In one embodiment, social network 105 may host many different applications, websites, modules, or components. For example, social network 105 may utilize a security module for protecting sensitive user information, an advertising module for displaying advertisements, and a suggestion module for providing suggestions of things for users to do, such as connect with new users.

### Verifying an Identity of a User

As shown in FIG. 1, social network 105 executes a verification module 115. Verification module 115 includes functionality to verify users of social network 105. In one embodiment, verification module 115 receives a request from another module or component of social network 105, or from an administrator of social network 105. The request may be in any format now known or later developed, and may indicate a target user for verification. The request may be in response to suspicious activity associated with the target user. For example, the target user may have sent out a large number of connection requests to users of the social network, and may be a suspected advertiser or other malicious user. As another example, the target user may utilize a username/password combination to access social network 105. If a third party service also utilized by the target user has a data breach, and the same username/password combination is determined to be in the breach, the target user may be flagged for verification to ensure that a malicious user is not impersonating the target user.

In one embodiment, verification module 115 includes functionality to identify users connected to other users in the social network. The identification may be performed in any suitable manner, such as accessing user database 110 and/or performing calculations on connection information, such as an intersection. In particular, verification module 115 is able to identify a first user connected to the target user. The first user may be chosen at random, or may be identified based on any suitable factor. In one embodiment, the first user may be used as the subject of a verification question, such as, “who is the first user connected with?”

Additionally, verification module 115 includes functionality to identify a second user connected to both the target user and the first user. Specifically, the second user may be the “correct” answer to the verification question, and may be identified using any suitable method.

In one embodiment, verification module 115 includes functionality for identifying other users. Any number of other users may be identified in any suitable manner. In one embodiment, the other users may be used as “incorrect” answers for the verification question. The other users may be connected to the target user. Alternatively, the other users may not be connected to the target user. As part of the process of identifying other users, verification module 115 may filter the other identified users of the social network in an attempt to remove other potential correct answers to the verification question. For example, other users may in fact know the first user (e.g., from school, work, etc.) but are not connected to the first user in social network 105. The target user may believe that the first user is connected to (or otherwise knows) the other users. Thus, to avoid potential confusion, a filter may be used to remove any other (or “incorrect”) user who went to school with the first user, worked at the same company as the first user, is a member of a group with the first user, etc.

In one embodiment, verification module 115 includes functionality to create a fake user. The fake user may be created using, for example, a profile picture from a user unconnected to the target user, and a randomly generated name, or other identifying information. As another example, the fake user may utilize a stock photo as a profile picture, an image of a public figure, or an image from any other suitable source. In one embodiment, if the target user selects the fake user as an answer to the verification question, then a consequence of such an incorrect result may be more serious than if the target user selects a “real” user that the target user is connected to. Example consequences include automatic denial of verification and blocking of the target user's account.

In one embodiment, verification module 115 includes functionality to receive a response to the verification question. The response may be received in any suitable format, and in any manner now known or later developed. In one embodiment, verification module 115 includes functionality to track the amount of time taken by the target user to respond to the verification question, and optionally adjust the accuracy of the response based on the amount of time taken. For example, a low and/or high threshold may be set, and if the target user responds faster than the low threshold, or slower than the high threshold, then the response may be counted as incorrect, even if the response contained a “correct” answer. The low threshold may be, for example, 1.5 seconds, 2 seconds, or any other suitable amount of time. Similarly, the high threshold may be 20 seconds, 30 seconds, or any other suitable amount of time. The use of the thresholds may stop target users from using automated scripts that randomly select an answer, or may stop target users from researching the displayed individuals to determine the correct answer.

In one embodiment, verification module 115 includes functionality to generate and display multiple different verification questions, and track responses from the target user across multiple different verification questions. Any number of verification questions may be used in verifying a target user. For example, five different verification questions may be presented for verification. Alternatively, three different verification questions may be presented or any other amount of verification questions. In one embodiment, the target user needs to correctly answer a certain percentage of verification questions correctly to be verified, such as 80%. The percentage may be higher, such as 90%, lower, such as 50%, or any other suitable amount. Alternatively, a target user is required to answer a certain number of questions in a row, such as two or three. If not, then verification module 115 continues to present verification questions to the target user, unless verification module 115 determines that the target user should be blocked from access to social network 105 after, for example, two or three incorrect answers in a row.

In one embodiment, the users in each verification question are unique. Alternatively, some users may be used in multiple verification questions for the same target user. For example, the same first user to which a target user is connected is presented in multiple verification questions, and a different set of other users is presented for each of the verification questions. As another example, if a target user selected an “other user” that is incorrect, then verification module 115 uses that other user as a correct answer in a subsequent verification question, since a human user impersonating the target user may be less likely to select that other user.

Network 108 comprises a communications network, such as a local area network (LAN), a wireless LAN (WLAN), a wide area network (WAN), a wireless WAN (WWAN), a metropolitan area network (MAN), an ad hoc network, an intranet, an extranet, a virtual private network (VPN), a portion of the Internet, the Internet, a portion of a public switched telephone network (PSTN), a cellular network, or a combination of two or more such networks. When network 108 comprises a public network, security features (e.g., VPN/SSL secure transport) may be included to ensure authorized access within system 100.

Client device 125 is a computing device, including but not limited to: work stations, personal computers, general purpose computers, laptops, Internet appliances, hand-held devices, wireless devices, wired devices, portable or mobile devices, wearable computers, cellular or mobile phones, portable digital assistants (PDAs), smart phones, tablets, multi-processor systems, microprocessor-based or programmable consumer electronics, game consoles, set-top boxes, network PCs, mini-computers, and the like. Client device 125 includes applications, software, and/or other executable instructions to facilitate various aspects of the invention described herein. Specifically, client device 125 is able to display identifying information of users and a prompt asking the user of client device 125 to answer a verification question, and send a response to the verification question to social network 105. Client device 125 may also include additional applications or other interface capabilities to communicate with social network 105. In one embodiment, there may be any number of client devices, such as one per user of social network 105.

### Example Functional Implementation

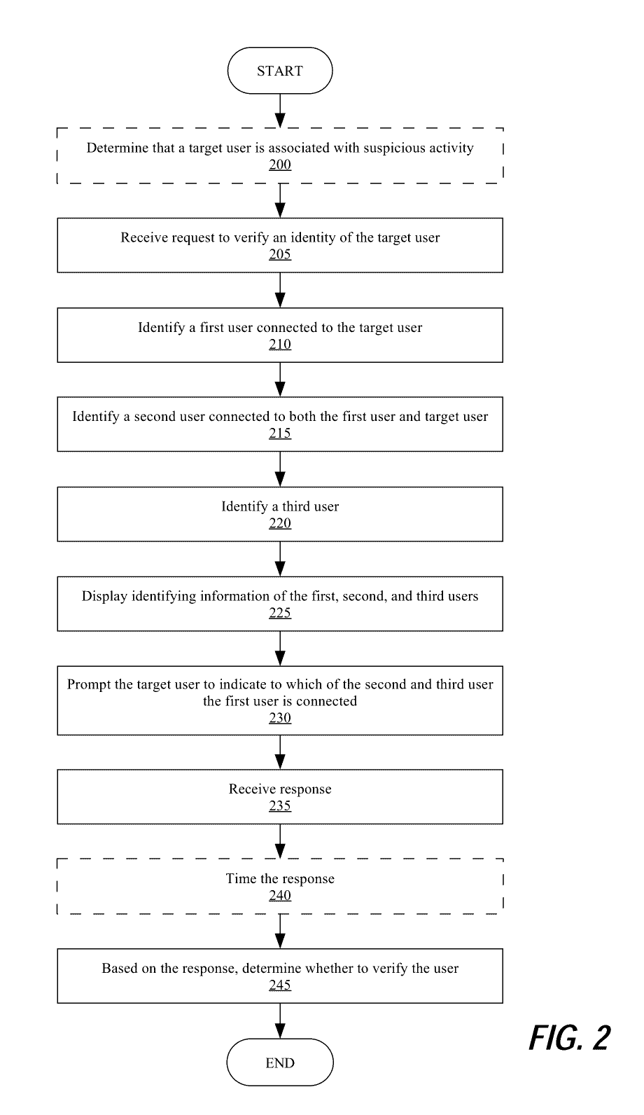

FIG. 2 shows an example flowchart of a method for connection prediction as identity verification. Although the steps in FIG. 2 are shown in an order, the steps of FIG. 2 may be performed in any order, and are not limited to the order shown in FIG. 2. Additionally, some steps may be optional, may be performed multiple times, and/or may be performed by different components.

In step 200, a target user associated with suspicious activity is determined. As indicated by the dotted line, step 200 may be an optional step, and/or may be performed by a different component or module. The target user may be associated with any kind of suspicious activity including, but not limited to: spamming, harassing users, violating rules of the social network, creating false profiles, impersonating users, hacking users, having a username/password released in a data breach, and/or any other reason.

In step 205, a request is received to verify an identity of the target user. The request may be received in any manner now known or later developed, and may be received from any source, such as another component, module, administrator, etc.

In step 210, a first user connected to the target user is identified. The first user may be identified in any suitable manner, such as randomly selecting a user from a list of users connected to the target user, and/or selecting a user based on one or more factors from a list of users connected to the target user. The factors may be any factor, including, but not limited to: a number of connections of the first user, a number of connections in common between the first user and the target user, a relation to the target user, age of the connection between the first user and the target user, etc. In one embodiment, the first user will be used as the subject of a verification question, where the target user may be prompted to answer one or more questions involving the first user.

In step 215, a second user connected to both the first user and the target user is identified. The second user may be identified in any suitable manner, such as randomly selecting a user from a list of users connected to both the first user and the target user, and/or selecting a user based on one or more factors, such as those described, above, in step 210.

In step 220, a third user is identified. The third user may be used as an incorrect choice to the verification question. The third user may be identified in any suitable manner, such as random selection or selection based on one or more factors. In one embodiment, a group of users may be identified in step 220, such as two, four, or more other users. The group of users may be filtered based on a variety of factors to try and reduce a “false positive” from happening. For example, the group of users may be filtered to remove any users who worked with the first user, went to school with the first user, are members of a group with the first user, etc. In one embodiment, the third user, and/or group of users, may be unconnected with the target user. Alternatively, the third user, and/or group of users, may be connected to the target user.

In step 225, identifying information of the first, second, and third users is displayed. Optionally, instead of displaying three users, more users may be displayed, such as five, six, or any other number of users. Many different types of identifying information may be presented including, but not limited to: a profile picture, a first name, a last name, a middle name, a work place(s), a degree(s) earned, a college or university attended, one or more groups associated with the user (i.e., a fraternity, a church, a volunteer organization, etc.), skills, and/or other data. The type of identifying information presented for each of the users may be the same. Alternatively, different types of identifying information may be presented for different users based on any suitable factor, such as what types of identifying information are available. In one embodiment, the identifying information is supplied by the user associated with the identifying information. In other words, the information used to identify “user A” was provided to the social network by “user A.” In one embodiment, two or more different types of identifying information may be displayed. Alternatively, one type of identifying information may be displayed.

In step 230, the target user is prompted to indicate to which of the second and third users the first user is connected. The target user may be prompted in any suitable manner, such as displaying a question similar to, “who is the first user connected to?” or “who does the first user know?”

In step 235, the response is timed. As indicated by the dotted lines, step 235 may be an optional step. The response may be timed in any manner now known or later developed. In one embodiment, there may be a low and a high threshold for the amount of time taken to receive the response. Specifically, if the response is received too quickly, or too slowly, then the response may be deemed incorrect, even if a correct answer was included with the response.

In step 240, a determination is made whether to verify the user, based on the responses. In one embodiment, the determination is made over the course of multiple question and answer pairs. The determination may be based on, for example, a percentage of correct answers exceeding a set amount, such as 75%, or any other suitable amount. If the target user is verified, the target user is able to continue using the social network as before. However, if the target user is not verified, the target user may be blocked from using the social network, have reduced functionality when using the social network, be subjected to another verification test or methodology, and/or any other suitable consequence.

### Example Use Case 1

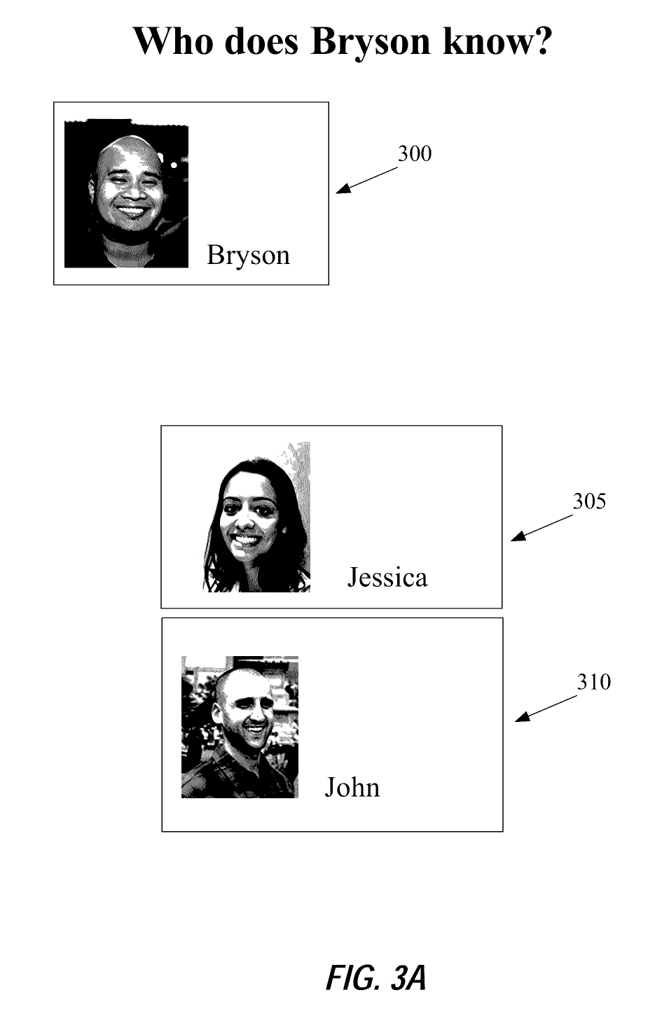

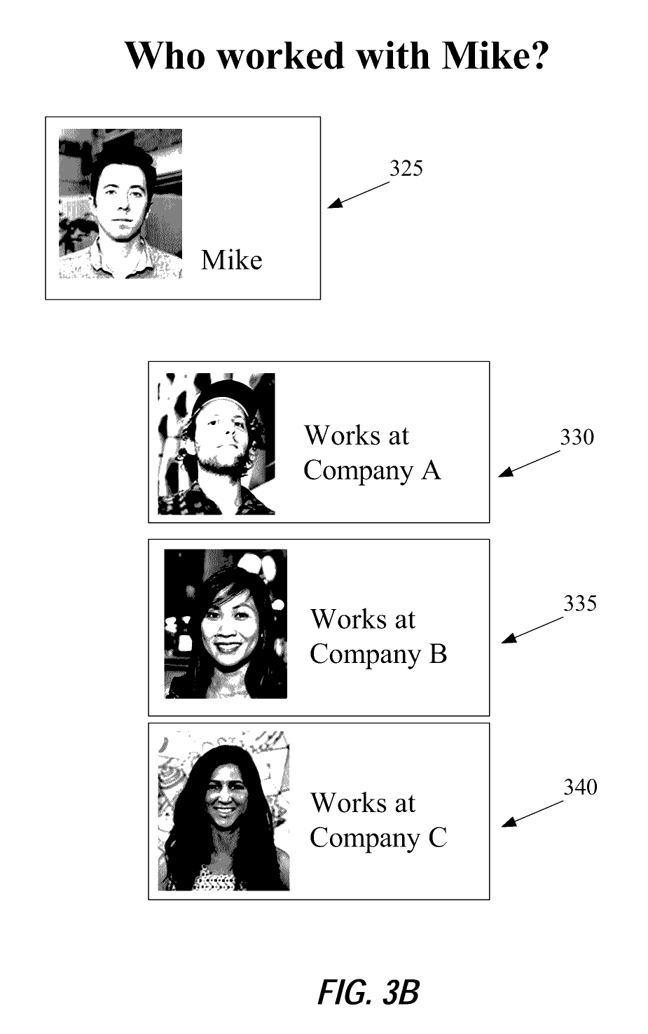

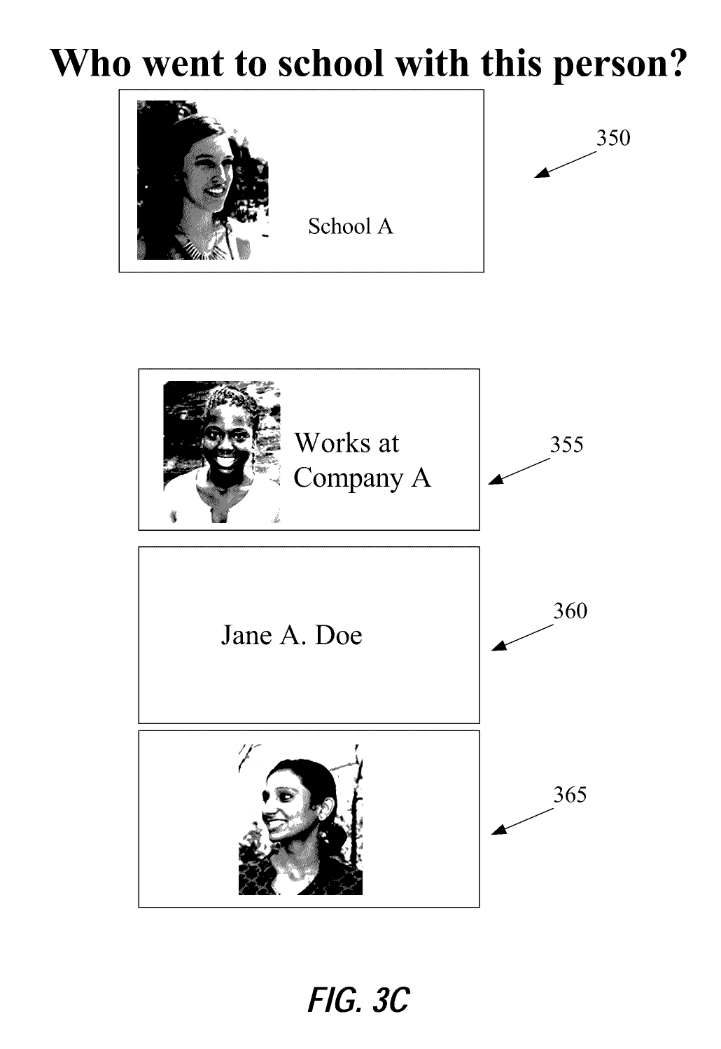

FIG. 3A shows an example use case. Specifically, a mock verification question and answer are shown in FIG. 3A. Block 300 shows a picture of the user “Bryson,” and the target user is being prompted to answer the question, “who does Bryson know?” The target user is able to select from two choices: Jessica as shown in block 305, or John as shown in block 310. In block 305, Jessica is identified using her profile picture and her first name, and in block 310 John is identified using his profile picture and his first name. The picture and name shown in block 305 were both provided by the user “Jessica,” and the picture and name shown in block 310 where both provided by the user “John.”

For the purposes of this example, the target user viewing this prompt knows Bryson and John from school, and knows Jessica from a church group. Additionally, Bryson worked with John and does not know who Jessica is. If the target user viewing this prompt is authentic, he or she would likely know that Bryson knows John (probably from school), and would also be able to determine that Bryson has likely never interacted with Jessica, and therefore would not know Jessica. However, if the target user viewing this prompt is not authentic, then he or she would likely not know who any of these people are, and could make a random guess at best. Thus, in this example, the target user provides a response indicating that Bryson knows John, and thus a determination would be made that the target user is authentic.

As an additional example, using the same facts as above, a timer may be started once the information shown in FIG. 3A is displayed to the target user. The timer tracks how long it takes the target user to respond to the prompt. If the target user does not know the answer (or is a bot), he or she may rapidly just make a selection between Jessica 305 and John 310. If the selection is too rapid, even if the target user correctly selects John 310, the response may be counted as incorrect and the target user will not be verified. Alternatively, if the response takes too long, it may be assumed that the target user does not know Jessica 305 and/or John 310, and may be searching the social network on another screen or account to determine which of Jessica 305 and/or John 310 knows Bryson 300. Thus, if the response takes too long, even if the target user correctly selects John 310, the response may be counted as incorrect and the target user will not be verified.

### Example Use Case 2

FIG. 3B shows a second example use case. Specifically, a second mock verification question and answer are shown in FIG. 3B. Block 325 shows a picture of the user “Mike,” and the target user is being prompted to answer the question, “who worked with Mike?” FIG. 3B offers three potential answers: block 330 shows a picture of a man who works at Company A, block 335 shows a picture of a woman who works at Company B, and block 340 shows a picture of a woman who works at Company C. As in FIG. 3A, the identifying picture and work information shown in blocks 330, 335, and 340 was supplied by the users identified in blocks 330, 335, and 340. If the target genuinely knows his or her connections, then they will likely know where Mike works, and can easily select the correct answer. In this example, Mike worked at Company B, and thus block 335 is the correct answer.

### Example Use Case 3

FIG. 3C shows a third example use case. Specifically, a third mock verification question and answer are shown in FIG. 3C. Block 350 shows a picture of a user and the school they attended, and the target user is being prompted to answer the question, “Who went to school with this person?” FIG. 3C offers three potential answers: block 355 shows a picture of a woman who works at company A, block 360 shows the name, “Jane A. Doe,” and block 365 shows a picture of another woman. The potential answers in FIG. 3C each show different combinations of identifying information. This is because some users do not completely fill out their profile. In this example, Jane A. Doe, from block 360, did not supply a profile picture when creating her account with the social network, and did not completely fill in the rest of her profile information either, and therefore is identified by name only. As another example, Jane A. Doe may be a fake user that was generated by the system. The user in block 365 is identified with only a picture. Having a single piece of identifying information may be used to increase the difficulty of the question. In this example, the user shown in block 365 also went to school A, and is therefore the correct answer.

### Hardware Overview

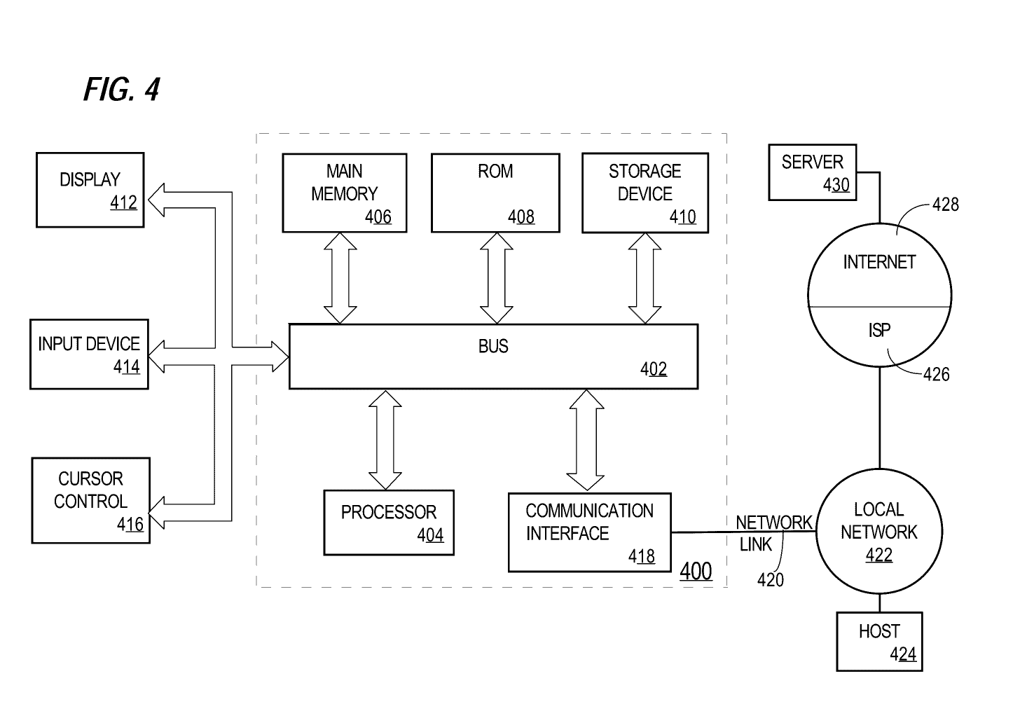

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
receiving, over a network, a request to verify an identity of a target user;
identifying a first user connected to the target user in an online social network, wherein the first user is connected to the target user based on the first user and the target user providing approval for connection;
identifying a second user that is connected to the first user and the target user, wherein the second user is connected to the first user based on the second user and the first user providing approval for connection, and wherein the second user is connected to the target user based on the second user and the target user providing approval for connection;
identifying a third user;
causing to be displayed, to the target user, a first identifying information of the first user, a second identifying information of the second user, and a third identifying information of the third user;
prompting the target user to indicate to which of the second user and the third user the first user is connected;
receiving, over the network, a response from the target user;
based on the response, allowing the target user to access an account of the target user;
wherein the method is performed by one or more computing devices.

2. (canceled)

3. The method of claim 1, further comprising:
calculating an amount of time between prompting the target user and receiving the response; and
in response to the amount of time exceeding a threshold, denying verification of the identity of the target user.

4. The method of claim 1, wherein the first identifying information comprises one or more selected from a group consisting of a picture, a name, a place of employment, a degree, a university, a nickname, a group, a hometown, a current city, an e-mail address, and a phone number.

5. The method of claim 4, wherein the first identifying information was supplied by the first user.

6. The method of claim 1, wherein identifying the third user comprises identifying the third user based on the third user being connected to the target user and the third user not being connected to the first user.

7. The method of claim 1, wherein identifying the third user further comprises:
filtering a plurality of users based on at least one factor to identify the third user, wherein the first user is associated with the at least one factor.

8. The method of claim 7, wherein the at least one factor comprises one or more selected from a group consisting of a current workplace, a former workplace, a university, and a group.

9. The method of claim 1, wherein identifying the third user further comprises:
creating a fake user by generating fake identifying information,
wherein selection of the third user by the target user results in a negative consequence.

10. The method of claim 1, wherein the request is received in response to suspicious activity associated with the target user being detected.

11. A system comprising:
one or more processors;
one or more computer-readable media storing instructions which, when executed by the one or more processors, cause:
receiving, over a network, a request to verify an identity of a target user;
identifying a first user connected to the target user in an online social network, wherein the first user is connected to the target user based on the first user and the target user providing approval for connection;
identifying a second user that is connected to the first user and the target user, wherein the second user is connected to the first user based on the second user and the first user providing approval for connection, and wherein the second user is connected to the target user based on the second user and the target user providing approval for connection;
identifying a third user;
causing to be displayed, to the target user, a first identifying information of the first user, a second identifying information of the second user, and a third identifying information of the third user;
prompting the target user to indicate to which of the second user and the third user the first user is connected;
receiving, over the network, a response from the target user; and
based on the response, allowing the target user to access an account of the target user.

12. (canceled)

13. The system of claim 11, wherein the one or more computer-readable media storing instructions which, when executed by the one or more processors, further cause:
calculating an amount of time between prompting the target user and receiving the response; and
in response to the amount of time exceeding a threshold, denying verification of the identity of the target user.

14. The system of claim 11, wherein the first identifying information comprises one or more selected from a group consisting of a picture, a name, a place of employment, a degree, a university, a nickname, a group, a hometown, a current city, an e-mail address, and a phone number.

15. The system of claim 14, wherein the first identifying information was supplied by the first user.

16. The system of claim 11, wherein identifying the third user comprises identifying the third user based on the third user being connected to the target user and the third user not being connected to the first user.

17. The system of claim 11, wherein identifying the third user further comprises:
filtering a plurality of users based on at least one factor to identify the third user, wherein the first user is associated with the at least one factor.

18. The system of claim 17, wherein the at least one factor comprises one or more selected from a group consisting of a current workplace, a former workplace, a university, and a group.

19. The system of claim 11, wherein identifying the third user further comprises:
creating a fake user by generating fake identifying information,
wherein selection of the third user by the target user results in a negative consequence.

20. The system of claim 11, wherein the request is received in response to suspicious activity associated with the target user being detected.
